(19) United States
(12) Patent Application Publication
(10) Pub. No.: US 2014/0254897 A1
(43) Pub. Date: Sep. 11, 2014

(54) DESIGN VERIFICATION AND DIAGNOSTICS FOR IMAGE DEVICES

(71) Applicant: TEKTRONIX, INC., Beaverton, OR (US)

(72) Inventor: Kevin Ferguson, Beaverton, OR (US)

(73) Assignee: TEKTRONIX, INC., Beaverton, OR (US)

(21) Appl. No.: 13/787,622

(22) Filed: Mar. 6, 2013

(51) Int. Cl. G06F 17/50

(52) U.S. Cl. CPC G06F 17/50
USPC 382/128

(57) ABSTRACT

A design of a medical imaging device may be proven by generating perceptual differences using a model of the medical imaging device and a reference model. The model of the medical imaging device may be changed if the perceptual difference are too large. Perceptual contrast difference summaries may be generated for all generated perceptual contrast differences, or those for a particular time or area.

### FIELD OF THE INVENTION

This disclosure is directed to video system design, and, more particularly, to systems and methods of designing image displays to meet reference standards.

### BACKGROUND

It is especially important that image display devices such as screens and printers used for medical purposes produce images that are accurate and preserve intelligibility of key medically pertinent features within the image. Designers of medical equipment, however, have difficulty in assessing, before such equipment is actually produced, how effective their products will portray vital medical information in medical images.

The American Association of Physicists in Medicine (AAPM) has produced recommended specifications for image terminals, published as AAPM On-Line report No. 03, 2005. Tolerances, such as amounts of acceptable variation, remain unspecified for display factors like luminance, resolution, noise, and given ambient light, and therefore device designers have few standards for design.

Because such outputs may be used for diagnostics, the dangers of not optimizing medical device output could be tragic. A poor display may result in misdiagnosis or non-diagnosis. Perhaps less obvious, generating images having poor quality may subject patients to unnecessary testing. If the testing involves radiation, for example, then the non-optimized devices could be subjecting the patients to unnecessary risk in the form of radiation exposure, such as by forcing patients to undergo extra tests or tests that have higher levels of radiation than would otherwise be necessary.

Previous attempts to specify particular parameters for test signals have used the Barten Model as a human vision model. The Barten Model uses a curve known as the Barten Curve that maps a transfer curve vs. luminance level. This simple model for mapping luminance to perceptual response does not take into account important aspects of the light stimulus reaching the eye from the image. There are many important factors unaccounted for in the Barten Model, such as resolution, noise, given ambient light, and image spatial spectral content. The AAPM recommends a visual inspection of medical image-producing devices using test images. The test images include examples of radiology as well as sine waves and other test patterns. In addition to being time consuming, measurements cannot be made until after the device has been produced, or at least prototyped, which makes for very inefficient design optimization.

Embodiments of the invention address these and other limitations of the prior art.

### SUMMARY OF THE INVENTION

Aspects of the invention include verifying a design of a medical imaging device and include operating an imaging comparison system. For example, the method may include setting a reference model or model parameters in the image comparison system and setting a first model or model parameters for a test device, such as a video display or a printer. Then an image that has been process using the reference model is compared to the same image processed using the first test device model. Next a perceptual contrast difference score is generated based on the comparison. In some embodiment if the perceptual contrast difference is above a threshold, the process is repeated by changing the first model for the test device to another model or using other parameters, and the image comparison re-run until the perceptual contrast difference is below the threshold.

The perceptual contrast difference may mean generating an output of the highest perceptual contrast difference value of all generated perceptual contrast differences, or it may be limited in time or area.

### BRIEF DESCRIPTION OF THE DRAWINGS

FIG. 1 is a block diagram of a design verification system according to embodiments of the invention.

FIG. 2 is a flow diagram illustrating example methods according to embodiments of the invention.

### DETAILED DESCRIPTION

This disclosure generally considers design for display devices, and in particular display devices for medical imaging. Such devices may include at least displays, such as monitors and screens that show images using light, such as Cathode Ray Tubes (CRTs), Light Emitting Diode displays (LEDs) or Organic LEDs (OLEDs), Plasma, Liquid Crystal Display (LCD) screens, etc., or may include printing devices capable of producing physical images. Although description below is given with reference to display devices only, it is understood that embodiments of the invention are applicable to all types of image generation devices.

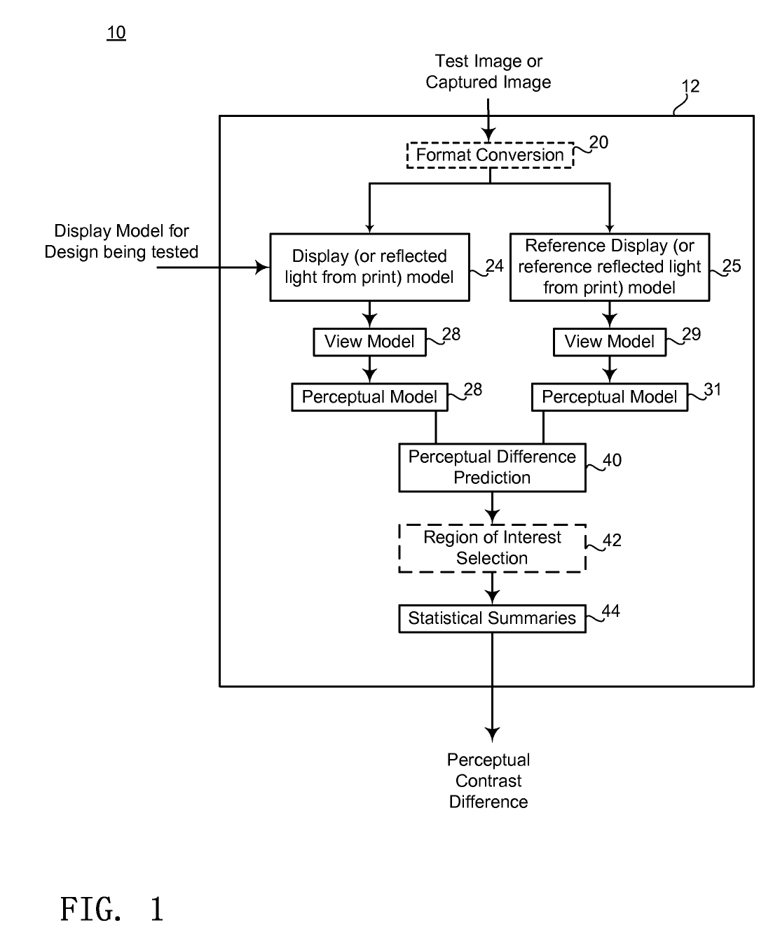

FIG. 1 is a block diagram of a display design verification system 10 according to embodiments of the invention. Several components of the design verification system 10 are described in a model called Moving Image Color Appearance Model (MICAM), which is described in a U.S. patent application Ser. No. 12/635,456, filed on Dec. 10, 2009 entitled METHOD AND APPARATUS FOR IMPLEMENTING MOVING IMAGE COLOR APPEARANCE MODEL FOR VIDEO QUALITY RATINGS PREDICTION, and incorporated by reference herein. Previous uses of this model, however, included generating a perceptual contrast difference report of two different images—a test image compared to a reference image. Embodiments of the design verification system 10 uses a single image, however, as described in more detail below.

Diagnostic related intelligibility optimization of a particular device is dependent upon device specifications such as resolution, maximum luminance, input/output transfer curve (nominally termed a “gamma” curve), temporal responses, colorimetry, etc. Device models reflect device technologies. For example, for best accuracy, the mathematical model for a liquid crystal technology based display (LCD) would be distinctly different from the mathematical model for a cathode ray tube (CRT) technology or light emitting diode (LED) technology based display. Then, for a given technology, the models themselves may vary in complexity vs. accuracy. Once a model is chosen, generally there are design parameters that reflect the device specification that may be varied. For example, for an LED based display, the maximum luminance is a parameter that could be set. Optimization of diagnostic related intelligibility using embodiments of the invention may incorporate any or all of these design choices, such as choice of technology, choice of model within the technology, and choice of parameters (specifics determined by the technology and model choices) reflecting the specifications.

The display design verification system 10 includes an embodiment 12 of MICAM, introduced above. In the MICAM 12 of FIG. 1, a single test image is received, which may be converted to a usable form using an optional format converter 20.

Additionally received is a display model 24 for the device being designed or tested. The display model describes output behavior of the display depending on particular inputs. The display model for the device being designed is stored as reference 24 in the MICAM 12.

Similarly, a display model 25 used as a reference is also stored. The reference display model 25 may be made from a simulated image, or a particularly high quality image to be used as reference. In other embodiments the reference display model 25 may be generated by using an average of multiple different images to create a very high quality image. In other embodiments the reference display model 25 may be generated based on data from the AAPM reference described above, or based on data from a publication entitled “Toward Clinically Relevant Standardization of Image Quality,” Journal of Digital Imaging, December, 2004, pp 271-278. The reference display model 25 may also be developed by using design parameters of an ideal display, or parameters of a very accurate display may be physically measured. In other embodiments the output may be simulated by software.

The display models 24, 25 convert respective inputs to simulated light for input to the respective view and perceptual models 28, 29, 30, and 31. The respective perceptual models 30, 31 output respective color response per spatial (e.g. pixel) and temporal (e.g. frame) samples in units of CIECAM02 {a,b}. CIECAM02 is the widely known Color Appearance Modeling for Color Management Systems, Published in 2002 by the CIE Technical Committee 8-01. These respective {a,b} video responses are used to estimate perceived differences between the reference display and the display being designed, as described below.

In addition to the perceptual models 30, 31, cognitive models, such as found in the TEKTRONIX PQA 500/600 quality analyzers may be included in the system. The region of interest within the images may be selected in a selector 42, which may be a region in either space or time or both. In some embodiments a default region of interest is the entire frame(s) for the entire length of the test and reference image(s). The output of the MICAM 12 is a set of statistical summaries of perceptual contrast difference, such as Difference Mean Opinion Score (DMOS) and/or a Picture Quality Rating (PQR).

With reference back to FIG. 1, it can be seen that there are a number of ways to compare the display being designed to a reference display. The image from the device being designed may be either directly input to the display model 24, converted for input to the display model, converted to light for input to the perceptual model 28, or directly input as light to the perceptual model 28. The particular conversion depends on the particulars of the input as well as the level of simulated light, which in a preferred embodiment is in units of nits (candelas/square meter). Additionally, images may be repeated as in video having identical frames. Conversion from an image to video may be performed in many ways as is known in the art. One particular test first converted files from a .tiff format to a .bmp format, then converted from the .bmp format to a .yuv format. The .yuv formatted files were replicated and concatenated to a series of repeated frames, yielding a few seconds of video.

As mentioned above, typically the region of interest for generating the perceptual contrast difference output is the entire test image. In a qualifying device, the preferred perceptual contrast difference maximum across the image is less than 0.1%, which is nominally equal to 1 Just Noticeable Difference (JND). Headroom is represented in the amount under 0.1%, and the magnitude of the amount exceeding the perceptual threshold is represented by the amount above 0.1%.

Specific diagnostic measures of noncompliance may be performed, for example by using the spatial region of interest to select test patterns for particular use cases, such as for resolution.

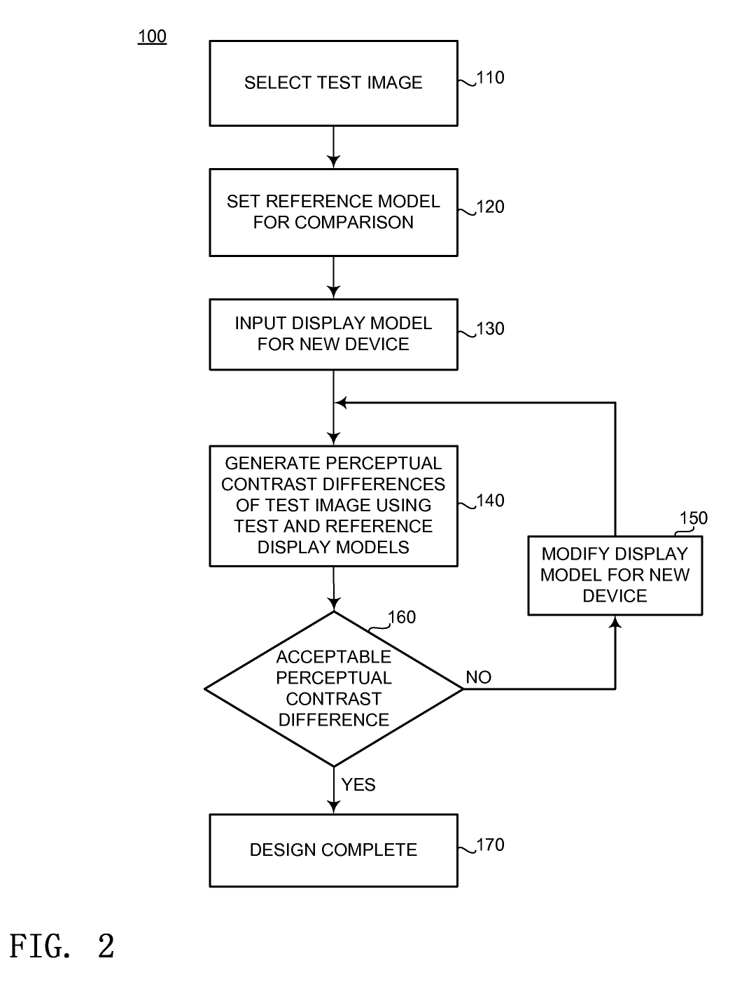

With reference to FIG. 2, an example method 100 according to embodiments of the invention is illustrated. In an operation 110 a single test image is selected to be evaluated by both a reference system and a system being designed or specified. A model for the reference system is specified or controlled by various parameters, or a previous created reference model is selected and set in an operation 120.

It is to the selected reference that the device being designed is compared, using the image selected in the operation 110, to determine whether the output quality of the device is close to the reference.

The model for the device being developed is set in an operation 130. Parameters for the model are typically developed by the manufacturer based on performance of the device, or may be measured, for example, during a prototyping stage. For instance, luminance values maybe be measured from a prototype display to see how the output changes depending on certain inputs. These values may be translated into the display model for the device being developed.

In an operation 140, the MICAM system 12 described above makes its comparison between the reference model and the model of the device being developed, and generates an output in terms of perceptual contrast difference. In other words, the MICAM system 12 generates an output that describes whether the device being developed has an output that is nearly the same as the reference. Or, if the device being developed is different than the reference, then the output describes whether those differences would be detectible to a user, and by how much.

If the differences are too great, meaning that the output of the device being developed is too different from the reference, using human perceptual differences, then the device being modeled should be changed for best performance. In a process 150, a new model is determined or parameters of the model are varied and the flow 100 loops back to the operation 140 where the comparison is again made. In one embodiment the comparison is the maximum perceptual contrast across every part of the display. The loop continues until the measured perceptual differences are within the level of acceptable difference, in which case the operation 160 exits in the YES direction, and that portion of the design is complete. Then the device may be built to the specifications used to develop the model for the operation 150 that ultimately successfully passed the perceptual difference test of operation 160.

Advantage to embodiments of the invention is that what have been referred to as “unknown variations” of the AAPM may be, in fact, determined, so that the subjective quality may be accurately quantified and checked to within a 1 JND tolerance to verify perceptual equivalence of the device being designed against the ideal standard reference device. Improved display and printer performance relative to parameters for optimum intelligibility of images in turn improves diagnosis and, in some cases, may reducing heath risk by reducing factors such as exposure to radiation.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated.

In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A method of verifying a design of a medical imaging device, the method comprising:
setting a reference model in an image comparison system;
setting a first test model for a test device in the image comparison system;
comparing an image processed using the reference model to the same image processed using the first test model in the image comparison system; and
generating a perceptual contrast difference score based on the comparison.

2. The method of verifying a design of a medical imaging device according to claim 1, the method further comprising:
determining that the perceptual contrast difference is above a threshold; and
replacing the first test model for the test device with a second test model for the test device.

3. The method of verifying a design of a medical imaging device according to claim 2, further comprising:
comparing an image processed using the reference model to the same image processed using the second test device model in the image comparison system.

4. The method of verifying a design of a medical imaging device according to claim 2, further comprising:
repeatedly modifying a past test device model with a present test device model until a comparison of an image processed using the reference model to the same image processed using the present test device model in the image comparison system is below a threshold level of perceptual contrast difference.

5. The method of verifying a design of a medical imaging device according to claim 2, in which generating a perceptual contrast difference comprises generating an output of the highest perceptual contrast difference value of all generated perceptual contrast differences.

6. The method of verifying a design of a medical imaging device according to claim 2, in which generating a perceptual contrast difference comprises generating an output of the highest perceptual contrast difference value of all generated perceptual contrast differences in a particular area.

7. The method of claim 1 in which setting a first test model for a test device comprises setting a first test model for a video display.

8. The method of claim 1 in which setting a first model for a test device comprises setting a first test model for a printer.

9. The method of claim 1 in which setting a reference model for a reference device comprises setting a reference model for a reference display.

10. The method of claim 1 in which setting a reference model for a reference device comprises setting a reference model for a reference printer.

11. A method of operating an image comparison system, comprising:
selecting a reference model derived from reference parameters in the image comparison system;
selecting a first model for a test device in the image comparison system;
comparing an image processed using the reference model to the same image processed using the first model for the test device in the image comparison system; and
generating a perceptual contrast difference score based on the comparison.

12. The method of verifying a design of a medical imaging device according to claim 11, the method further comprising:
determining that the perceptual contrast difference is above a threshold; and
replacing the first model for the test device with a second model for the test device.

13. The method of verifying a design of a medical imaging device according to claim 12, further comprising:
comparing an image processed using the reference model to the same image processed using the second model for the test device in the image comparison system.

14. The method of verifying a design of a medical imaging device according to claim 12, further comprising:
repeatedly exchanging a past model for the test device for a current model for the test device test model until a comparison of an image processed using the reference model to the same image processed using the current model for the test device in the image comparison system is below a threshold level of perceptual contrast difference.

15. The method of verifying a design of a medical imaging device according to claim 12, in which generating a perceptual contrast difference comprises generating an output of the highest perceptual contrast difference value of all generated perceptual contrast differences.

16. The method of verifying a design of a medical imaging device according to claim 12, in which generating a perceptual contrast difference comprises generating an output of the highest perceptual contrast difference value of all generated perceptual contrast differences in a particular area.

17. The method of claim 10 in which selecting a first model for a test device comprises selecting a first model for a video display.

18. The method of claim 10 in which selecting a first model for a test device comprises selecting a first model for a printer.

19. The method of claim 10 in which selecting a reference model for a reference device comprises selecting a reference model for a reference display.

20. The method of claim 10 in which selecting a reference model for a reference device comprises selecting a reference model for a reference printer.
